(19) United States
(12) Patent Application Publication
(10) Pub. No.: US 2025/0242551 A1
(43) Pub. Date: Jul. 31, 2025

(54) METHOD OF PRODUCING HOLLOW BODY AND APPARATUS THAT PRODUCES HOLLOW BODY

(71) Applicant: TOYOTA JIDOSHA KABUSHIKI KAISHA, Toyota-shi (JP)

(72) Inventors: Kei KATO, Nagakute-shi (JP); Junya MAEDA, Toyota-shi (JP)

(73) Assignee: TOYOTA JIDOSHA KABUSHIKI KAISHA, Toyota-shi (JP)

(21) Appl. No.: 18/931,626

(22) Filed: Oct. 30, 2024

(30) Foreign Application Priority Data
Jan. 30, 2024 (JP) 2024-011646

(51) Int. Cl. B29C 70/32; B29L 31/00

(52) U.S. Cl. CPC B29C 70/32; B29L 2031/7156

(57) ABSTRACT

A method of manufacturing a hollow body using a mandrel includes an impregnation step of impregnating a fiber with a resin, a winding step of winding the fiber impregnated with the resin around a surface of the mandrel, and a loading step of applying a load to a fiber layer formed on a surface of the mandrel by the winding step by pressing a roller.

### CROSS-REFERENCE TO RELATED APPLICATION

This application claims priority to Japanese Patent Application No. 2024-011646 filed on Jan. 30, 2024, incorporated herein by reference in its entirety.

### BACKGROUND

### 1. Technical Field

The technique disclosed herein relates to a method of producing a hollow body using a mandrel and an apparatus that produces a hollow body.

### 2. Description of Related Art

According to Japanese Unexamined Patent Application Publication No. 2021-50433 (JP 2021-50433 A), there is a technique of winding a fiber-reinforced resin member around the outer peripheral surface of the high-pressure container as a body to be braided by a braiding machine.

### SUMMARY

When fibers are wound around an object to be wound, air may be entrained, causing a large number of fine air gaps called voids in a fiber layer formed on the surface of the object. The voids cause a decrease in the strength of the fiber layer after curing. Therefore, the improvement is required to increase the strength of such a fiber layer.

Disclosed herein is a method of producing a hollow body using a mandrel.

The method includes:
impregnating fibers with a resin;
winding the fibers impregnated with the resin on the surface of the mandrel; and
applying a load to a fiber layer formed on the surface of the mandrel by the winding by pressing a roller against the fiber layer.

According to the above configuration, the fiber layer is compressed by the loading, and the air of the voids in the fiber layer is pushed out of the fiber layer. As a result, the strength of the fiber layer formed on the surface of the mandrel after curing is improved and stabilized.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a simplified view of a hollow body manufacturing system;

FIG. 2 is a partial cross-sectional view of a portion of a hollow body manufacturing system;

FIG. 3 shows a plurality of rollers from a front-to-rear perspective;

FIG. 4 is a partial cross-sectional view showing the vicinity of the roller in a simplified manner; and

FIG. 5 is a view showing an image of a cross section of a conventional hollow body.

### DETAILED DESCRIPTION OF EMBODIMENTS

Embodiments will be described with reference to the drawings. Each of the drawings is merely an example, and the present embodiment is not limited to the illustrated contents. In addition, since each of the drawings is an example, the illustrated shape is not accurate or a part thereof is omitted.

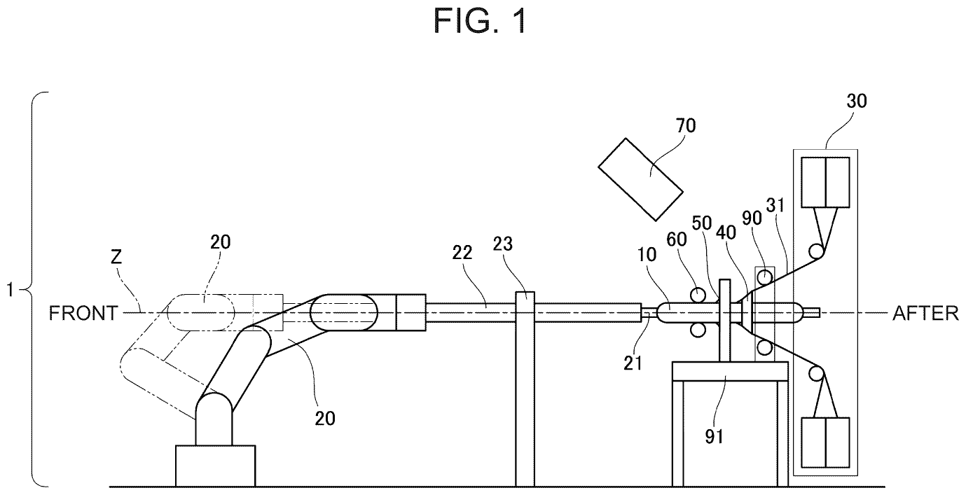

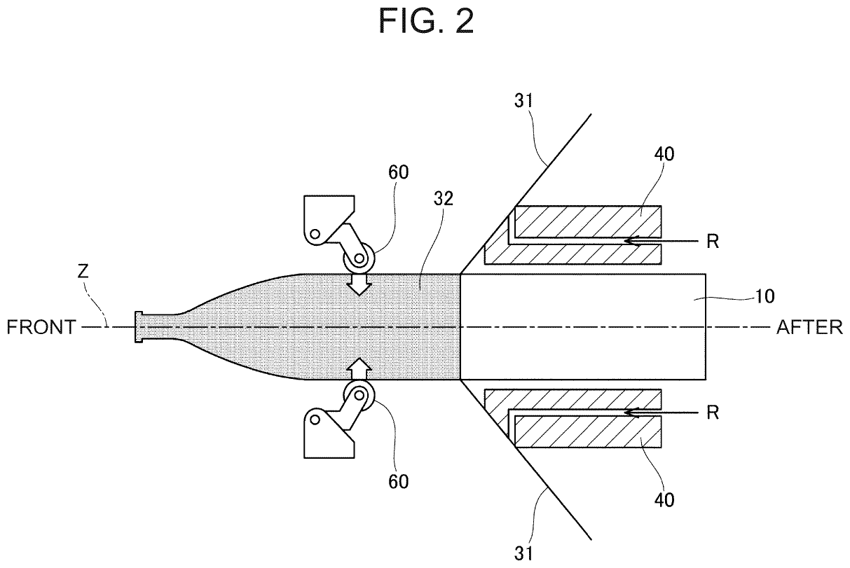

FIG. 1 schematically illustrates a hollow body manufacturing system 1 according to the present embodiment. FIG. 2 shows a portion of the hollow body manufacturing system 1 in an enlarged, partially sectional view more simply than in FIG. 1. Each figure includes a portion where the shapes and the like are not aligned with each other. For example, in FIGS. 1 and 4, and FIG. 2, although the shape of the end portion of the mandrel 10 is different, it may be either shape, such inconsistency does not affect the description of the present case. At least a portion of the hollow body manufacturing system 1 provides a method of manufacturing a hollow body using the mandrel 10. At least a part of the hollow body manufacturing system 1 corresponds to an apparatus for manufacturing a hollow body using the mandrel 10. Simply, the hollow body manufacturing system 1 may be regarded as the device.

According to FIG. 1, the hollow body manufacturing system 1 includes a robot arm 20 for moving while supporting a mandrel 10. The mandrel 10 has a hollow cylindrical member, and corresponds to, for example, an inner layer (liner) of a tank as a hollow body. As a more specific example, the mandrel 10 is formed of a resin such as nylon, and serves as an inner layer of a high-pressure tank for storing hydrogen and the like. A support shaft 21, which is coaxial with the horizontal Z-axis, passes through the mandrel 10. The mandrel 10 and the support shaft 21 may be understood to be coaxial. In the drawings, one side in the Z-axis direction is regarded as a front side, and the other side is regarded as a rear side.

A jig shaft 22 along the Z-axis direction is attached to the distal end of the robot arm 20, and the jig shaft 22 coaxially holds the support shaft 21. As indicated by a two-dot chain line in FIG. 1, the robot arm 20 can move the jig shaft 22, the support shaft 21, and the mandrel 10 forward along the Z-axis by moving at least a part thereof forward. That is, the mandrel 10 moves from the rear to the front on the Z-axis. The hollow body manufacturing system 1 may appropriately include a jig receiving portion 23 or the like that serves as a support for keeping the long jig shaft 22 horizontal. A pressure higher than the outside air pressure is applied to the inside of the mandrel 10, and the space between the support shaft 21 and the mandrel 10 is sealed so that the air in the mandrel 10 does not leak.

The hollow body manufacturing system 1 includes a winding machine 30, an impregnator 40, a remover 50, and rollers 60. The winding machine 30 is a machine for winding a wire to which a predetermined tension is applied in a net shape on a surface of an object to be wound, and includes a bobbin or the like on which the wire is wound. The winding machine 30 is also referred to as a braiding machine, a braider, or the like. Although simplified in FIG. 1, the winding machine 30 is formed in an annular shape so as to surround the Z-axis, and supplies a plurality of wires to the mandrel 10 from the periphery of the mandrel 10. Between the winding machine 30 and the winding machine 30 and the mandrel 10, rollers, rings, and the like for applying the necessary tension to the wire are provided as appropriate. The ring 90 is a kind of such a ring. The configuration and function of the winding machine 30 are known, and thus the details thereof will be omitted. In this embodiment, the winding machine 30 supplies fibers 31 (e.g., carbon fibers) to the mandrel 10.

The resin R is supplied to the impregnator 40 by a pressure from a pump (not shown). The impregnator 40 is also formed in an annular shape so as to surround the mandrel 10 moving on the Z axis. The impregnator 40 impregnates the respective fibers 31 supplied to the mandrel 10 by the winding machine 30 with the resin R at a timing before each fiber 31 reaches the mandrel 10. That is, an “impregnation step” in which the resin R is impregnated into the fiber 31 is performed by the impregnator 40. The fiber 31 impregnated with the resin R is wound in a net shape around the surface of the mandrel 10. The winding machine 30 consequently carries out a “winding process” of winding the fibers 31 impregnated with the resin R onto the surface of the mandrel 10.

By the winding process, a fiber layer 32 is formed on the surface of the mandrel 10. As described above, since pressure is applied to the inside of the mandrel 10, the mandrel 10 is prevented from being recessed or distorted during a winding process, a loading process to be described later, or the like. If the fiber 31 is a carbon fiber, the fiber layer 32 is a layer of carbon fiber and resin R Carbon Fiber Reinforced Plastics (CFRP).

The remover 50 is disposed at a predetermined position in front of a winding position in which the fiber 31 is wound around the mandrel 10. Further, rollers 60 are disposed at predetermined positions in front of the remover 50. However, the description of the remover 50 is omitted in FIG. 2. The portion of the mandrel 10 where the fiber layer 32 is formed passes through the position of the remover 50 and further passes through the positions of the rollers 60 as the mandrel 10 moves forward. Although details are omitted, the hollow body manufacturing system 1 may appropriately include a base 91 for mounting and supporting the respective components in order to support the remover 50 and the like at a required height.

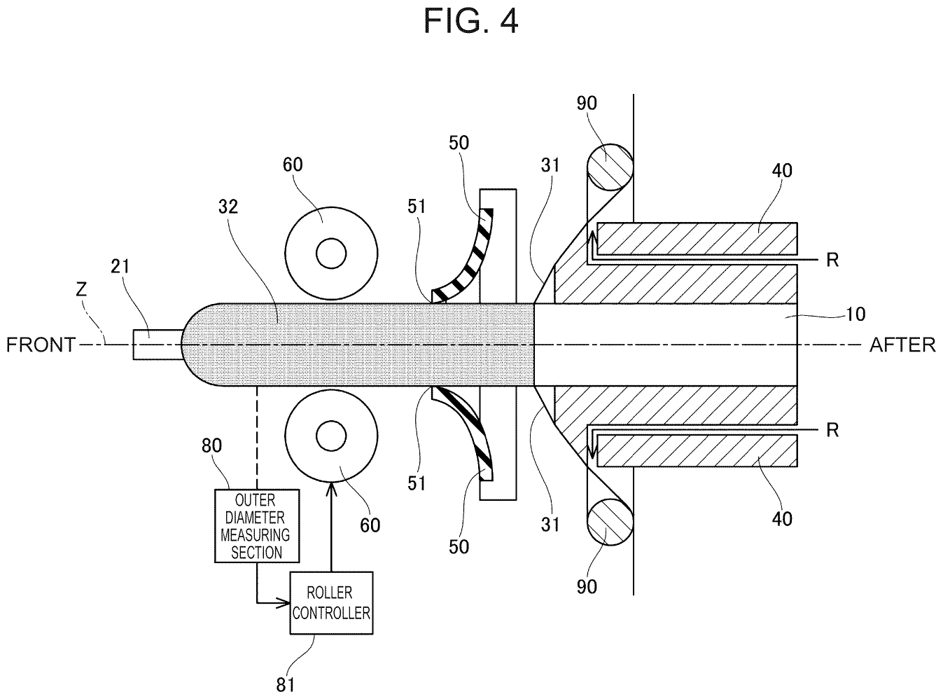

The remover 50 has a circular hole 51 (see FIG. 4) coaxial with the Z-axis through which the mandrel 10 can pass, and is formed in an annular shape. The circular hole 51 is formed in, for example, a rubber film. When the mandrel 10 on which the fiber layer 32 is formed passes through the circular hole 51 of the remover 50, the surface of the fiber layer 32 comes into contact with the edge of the circular hole 51, so that the resin R that cannot pass through the circular hole 51, that is, the excess resin is removed from the fiber layer 32. As described above, the present embodiment includes a “removing step” in which excess resin is removed from the fiber layer 32 by the remover 50 by passing the annular remover 50 through the mandrel 10 on which the fiber layer 32 is formed. The thickness of the fiber layer 32 is adjusted to be substantially constant by the removing step. The base 91 also serves as a resin receiver for receiving excess resin removed by the remover 50.

The rollers 60 are a means for realizing a “loading step” of applying a load to the fiber layer 32 by pressing against the fiber layer 32. The rollers 60 apply a load to the fiber layer 32 by the force of an elastic body such as a spring. The rollers 60 are also rotatable as the mandrel 10 moves along the Z-axis when in contact with the fiber layer 32.

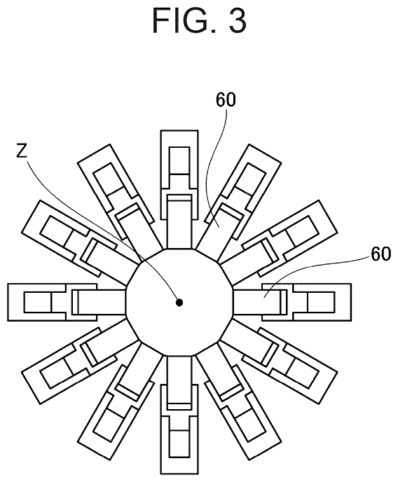

FIG. 3 shows the rollers 60 from a front-to-rear perspective. In the present embodiment, a plurality of rollers 60 are annularly arranged around the Z axis so as to surround the periphery of the mandrel 10. Then, the mandrel 10 in a state where the fiber layer 32 is formed on the surface passes through the central ring formed by the plurality of rollers 60. As a result, the fiber layer 32 is substantially evenly compressed from the periphery by the plurality of rollers 60. Further, according to the positional relationship between the remover 50 and the rollers 60 shown in FIG. 1, in the loading step, the rollers 60 are pressed against the fiber layer 32 from which the excess resin has been removed by the remover 50 to apply a load.

As shown in FIG. 1, in the hollow body manufacturing system 1, a hot air heater 70 is installed in the vicinity of the rollers 60 in front of a winding position where the fiber 31 is wound around the mandrel 10. The hot air heater 70 prevents the resin R from being cooled and solidified by applying hot air to the fiber layer 32 to be subjected to the removing step or the loading step. The number of hot air heaters 70 is not limited to one. Naturally, it is possible to move the hot air heater 70 or to adjust the temperature and the air volume of the hot air as necessary.

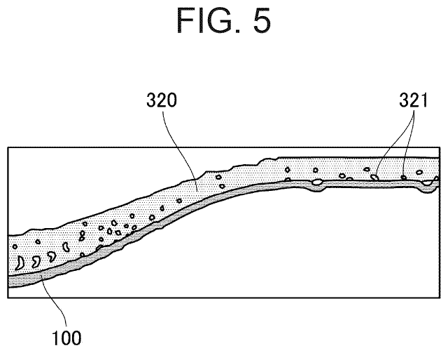

FIG. 5 is an image of a cross-section of a conventional hollow body, showing a cross-section of the mandrel 100 and the fiber layer 320. A fiber layer 320 is formed on the outside of the mandrel 100. As described above, when the fiber is wound around the object to be wound, air is entrained. Therefore, voids 321 are formed in the fiber layer 320 formed on the surface of the mandrel 100, and the voids 321 are a factor of reducing the strength of the fiber layer 320 after curing.

In order to solve such a problem, the method according to the present embodiment performs the impregnation step and the winding step, and further applies a load by pressing the rollers 60 against the fiber layer 32 formed on the surface of the mandrel 10 by the load step. According to such a configuration, the fiber layer 32 is compressed by the loading process, and the air of the void in the fiber layer 32 is pushed out of the fiber layer 32. That is, the voids do not remain confined within the fiber layer 32. Therefore, the strength of the fiber layer 32 formed on the surface of the mandrel 10 after curing is improved and stabilized. Further, according to the present embodiment, by combining the loading step and the removing step, voids in the fiber layer 32 can be removed together with the excess resin.

FIG. 4 is an enlarged partial cross-sectional view of the vicinity of the rollers 60. The hollow body manufacturing system 1 may include an outer diameter measurement unit 80 that measures an outer diameter of the mandrel 10 including the fiber layer 32 at a predetermined position in front of the rollers 60. The outer diameter measurement unit 80 measures the outer diameter of the mandrel 10 including the fiber layer 32 after the rollers 60 are pressed. The method of measuring the outer diameter by the outer diameter measurement unit 80 may be any method such as measurement by contact or measurement by non-contact. The measurement value of the outer diameter by the outer diameter measurement unit 80 is transmitted to the roller control unit 81.

The roller control unit 81 is capable of adjusting the load applied to the fiber layer 32 by the rollers 60, and includes, for example, an actuator that changes the positions of the rollers 60. The roller control unit 81 compares the measurement value by the outer diameter measurement unit 80 with the design value for the outer diameter of the mandrel 10 including the fiber layer 32, and adjusts the load by the rollers 60 so that the difference between the measurement value and the design value becomes as zero as possible. The load is adjusted by the rollers 60, for example, by changing the distance from the Z-axis to the rollers 60. As described above, in the loading step, the outer diameter of the mandrel 10 including the fiber layer 32 that has passed through the pressing of the rollers 60 is measured, and the load by the rollers 60 is adjusted in accordance with the measured outer diameter. According to this configuration, by feeding back the measured value of the outer diameter to the pressing of the fiber layer 32 by the rollers 60, it is possible to stabilize the thickness of the fiber layer 32 and the strength of the fiber layer 32 after curing.

The positional relationship between the remover 50 and the rollers 60 is not limited to the illustrated embodiment. The remover 50 may be disposed at a predetermined position in front of the rollers 60. In a configuration in which the remover 50 is located in front of the rollers 60, the fiber layer 32 subjected to a load and compressed by the rollers 60 is subjected to a removal process, and excess resin is removed by the remover 50.

The categories disclosed in the present embodiment are not limited to methods. An apparatus for manufacturing a hollow body using the mandrel 10 includes an impregnator 40 that impregnates the fiber 31 with the resin R, a winding machine 30 that winds the fiber 31 impregnated with the resin R around the surface of the mandrel 10, and rollers 60 that apply a load to the fiber layer 32 by pressing against the fiber layer 32 formed on the surface of the mandrel 10 by the winding machine 30.

According to the present embodiment, the mandrel 10 constitutes a hollow body such as a high-pressure tank together with the outer fiber layer 32. However, the mandrel 10 may be not included in the hollow body to be finally manufactured. That is, the hollow body to be manufactured refers to a product including the fiber layer 32 and the fiber layer 32 formed on the outside of the mandrel 10, and the mandrel 10 may be a mold used in the process of manufacturing such a hollow body.

While specific examples of the technology disclosed herein have been described in detail above, these are merely illustrative and do not limit the scope of the claims. Various modifications and variations of the specific examples described above are included in the technology described in the claims. In addition, the technical elements described in the present specification or the drawings exhibit technical usefulness alone or in various combinations, and are not limited to the combinations described in the claims at the time of filing. Further, the technology illustrated in the present specification or the drawings achieves a plurality of objects at the same time, and has technical usefulness by achieving one of the objects.

What is claimed is:

1. A method of producing a hollow body using a mandrel, the method comprising:
impregnating fibers with a resin;
winding the fibers impregnated with the resin on a surface of the mandrel; and
applying a load to a fiber layer formed on the surface of the mandrel by the winding by pressing a roller against the fiber layer.

2. The method according to claim 1, wherein In the applying, an outer diameter of the mandrel including the fiber layer that has been pressed by the roller is measured, and a load applied by the roller is adjusted in accordance with the outer diameter.

3. The method according to claim 1, further comprising removing an excess resin from the fiber layer by an annular removing machine while passing the removing machine over the mandrel on which the fiber layer is formed.

4. The method according to claim 1, wherein the mandrel is an inner layer of a high-pressure tank.

5. An apparatus that produces a hollow body using a mandrel, the apparatus comprising:
an impregnating machine that impregnates fibers with resin;
a winding machine that winds the fibers impregnated with the resin around a surface of the mandrel; and
a roller that applies a load to a fiber layer formed on the surface of the mandrel by the winding machine by pressing against the fiber layer.
